(19) United States
(12) Patent Application Publication
(10) Pub. No.: US 2012/0200537 A1
(43) Pub. Date: Aug. 9, 2012

(54) COORDINATE POSITION DETECTION DEVICE, METHOD OF DETECTING COORDINATE POSITION, AND DISPLAY DEVICE

(76) Inventor: Akihiro Okano, Kawasaki-shi (JP)

(21) Appl. No.: 13/501,580

(22) PCT Filed: Oct. 19, 2009
(86) PCT No.: PCT/JP2009/068024

§ 371 Date: Apr. 12, 2012

(51) Int. Cl. G06F 3/042

(52) U.S. Cl. 345/175

(57) ABSTRACT

When a coordinate detector detects a first light-blocking object, a display device conducts a first local simultaneous scanning process for scanning a local area including the first light-blocking object and an entire sequential scanning process for scanning the entirety of a display surface in parallel. Additionally, during the first local simultaneous scanning process and the entire sequential scanning process conducted in parallel, when a second light-blocking object is detected by the entire sequential scanning process, the display device conducts a second local simultaneous scanning process for scanning a local area including the second light-blocking object in parallel with the first local simultaneous scanning process.

### TECHNICAL FIELD

The present invention relates to a coordinate position detecting device, a method of detecting a coordinate position, and a display device.

### BACKGROUND ART

There has been known a typical arrangement usable for an optical touch panel or the like to detect a coordinate position in response to a predetermined input (see, for instance, Patent Literature 1 and Patent Literature 2).

Patent Literature 1 discloses an arrangement according to which when the coordinate position of a light-blocking object is detected by scanning the entire area of a display surface, a secondary scanning is conducted on a limited area, which is narrower than the area of the entire scanning, including the detected coordinate position of the light-blocking object.

According to an arrangement disclosed in Patent Literature 2, two light-emitting units each emit a plurality of probe light beams to a recursive reflecting member and two light-receiving units receive a recursive reflected light. Based on a position where the light intensity of the recursive reflected light received by the light-receiving unit(s) is minimum and a light-blocking range where a light intensity distribution at the light-receiving unit(s) is smaller than a predetermined value, the respective coordinates of a plurality of light-blocking objects are calculated.

### CITATION LIST

### Patent Literature(s)

Patent Literature 1: Japanese Patent No. 4286698

Patent Literature 2: JP-A-2003-122494

### SUMMARY OF THE INVENTION

### Problems to be Solved by the Invention

With the arrangement disclosed in Patent Literature 1, after the coordinate position of one light-blocking object is detected by the secondary scanning, the coordinate position of another light-blocking object in an area different from the area of the secondary scanning is unlikely to be detected. In other words, the respective coordinate positions of a plurality of light-blocking objects cannot be simultaneously detected.

With the arrangement disclosed in Patent Literature 2, the entire area of a touch panel surface is irradiated by the probe light even after detection of the respective coordinate positions of a plurality of light-blocking objects. Thus, positions distant from the light-blocking objects are also irradiated by the probe light, so that responsiveness is lowered and a favorable process cannot be conducted.

An object of the invention is to provide a highly responsive coordinate position detecting device with a simple arrangement that is capable of detecting the respective coordinate positions of a plurality of light-blocking objects, a method of detecting a coordinate position, and a display device.

### Means for Solving the Problems

According to an aspect of the invention, a coordinate position detecting device includes: a plurality of light-emitting elements being configured to sequentially emit a detection light in mutually intersecting directions along a planar direction of a display surface; a plurality of light-receiving elements being disposed at positions correspondingly opposed to the plurality of light-emitting elements to sequentially receive the emitted detection light so that when the detection light is blocked by a light-blocking object, a coordinate position of a light-blocked portion is detected based on a light-receiving amount of the light-receiving elements; a scanner being configured to scan a predetermined scanning area with the detection light; and a coordinate detector being configured to detect a coordinate position of the light-blocking object on the display surface based on a scanning position at which the light-blocking object blocks the detection light, in which when the coordinate detector detects the coordinate position of the light-blocking object less than a present plural reference number, the scanner is configured to conduct in parallel: a oblique-part scanning process in which the detection light is emitted from each one of the light-emitting elements and received by two or more of the light-receiving elements including one of the light-receiving elements opposed to the one of the light-emitting elements so as to sequentially scan only a vicinity of the light-blocking object less than the reference number; and an entire scanning process in which the detection light is emitted from each one of the light-emitting elements and received only by the light-receiving element opposed to the one of the light-emitting elements so as to sequentially scan an entirety of the display surface.

According to another aspect of the invention, a display device includes: a display including a display surface; and the coordinate position detecting device described above, the coordinate position detecting device being configured to detect a coordinate position of a portion light-blocked by a light-blocking object when a detection light emitted in mutually intersecting directions along a planar direction of the display surface of the display is blocked by the light-blocking object.

According to another aspect of the invention, a coordinate position detecting method for a computer to detect a coordinate position of a portion light-blocked by a light-blocking object when a detection light emitted in mutually intersecting directions along a planar direction of a display surface is blocked by the light-blocking object, includes: scanning a predetermined scanning area with the detection light, the scanning being conducted by the computer; and detecting a coordinate position of the light-blocking object on the display surface based on a scanning position at which the light-blocking object blocks the detection light, the detecting being conducted by the computer, in which, in the scanning, when the coordinate position of the light-blocking object less than a preset reference number is detected in the detecting, an oblique-part scanning process in which only a vicinity of the light-blocking object less than the reference number is sequentially scanned and an entire scanning process in which an entirety of the display surface is sequentially scanned are conducted in parallel, the detection light used for the oblique-part scanning process is provided by a mutually parallel light, an orthogonal light and an obliquely intersecting light, and a scanning time of the oblique-part scanning process is one half of a scanning time of the entire scanning process or less.

### BRIEF DESCRIPTION OF DRAWINGS

FIG. 1 is a block diagram schematically showing an arrangement of a display device according to first to third exemplary embodiments of the invention.

FIG. 2 is an explanation view showing an entire simultaneous scanning process and an entire sequential scanning process according to the first exemplary embodiment.

FIG. 3 is an explanation view showing a first local simultaneous scanning process according to the first exemplary embodiment.

FIG. 4 is an explanation view showing the first local simultaneous scanning process and a second local simultaneous process according to the first exemplary embodiment.

FIG. 5 is a flowchart showing a coordinate detecting process according to the first exemplary embodiment.

FIG. 6 is a flowchart showing a coordinate specifying process for two-point detection according to the first exemplary embodiment.

FIG. 7 schematically shows a light-blocked state with the presence of two light-blocking objects according to the first exemplary embodiment.

FIG. 8 schematically shows a light-receiving level at the time when light is blocked at a position distant from light-receiving elements according to the first exemplary embodiment.

FIG. 9 schematically shows a light-receiving level at the time when light is blocked at a position close to the light-receiving elements according to the first exemplary embodiment.

FIG. 10 is a block diagram schematically showing an arrangement of a display device according to a fourth exemplary embodiment of the invention.

### DESCRIPTION OF EMBODIMENT(S)

### First Exemplary Embodiment

A first exemplary embodiment of the invention will be initially described below with reference to the attached drawings.

### Arrangement of Display Device

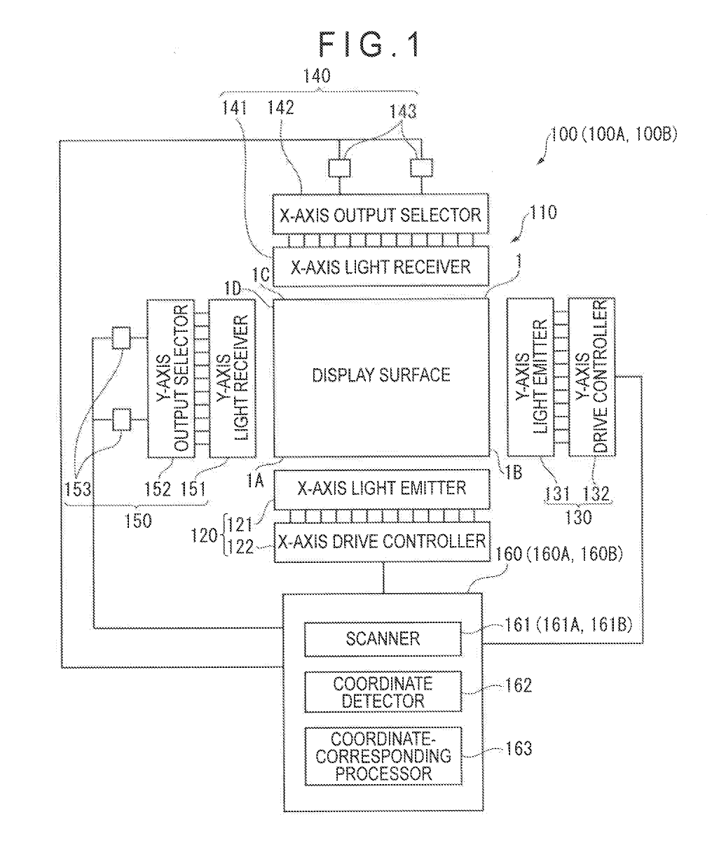

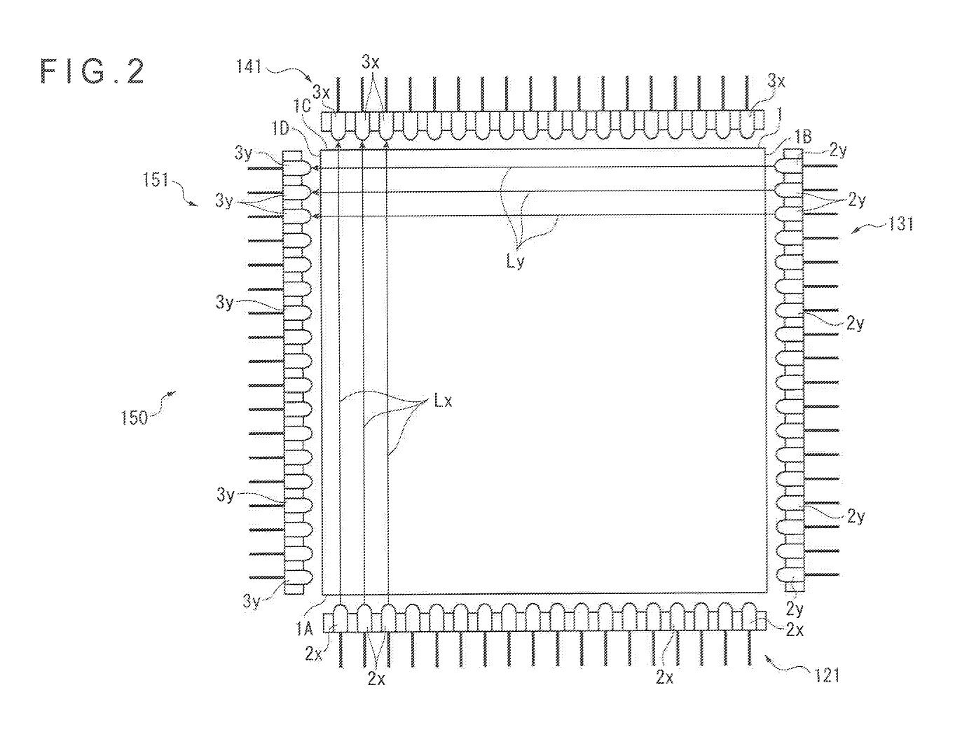

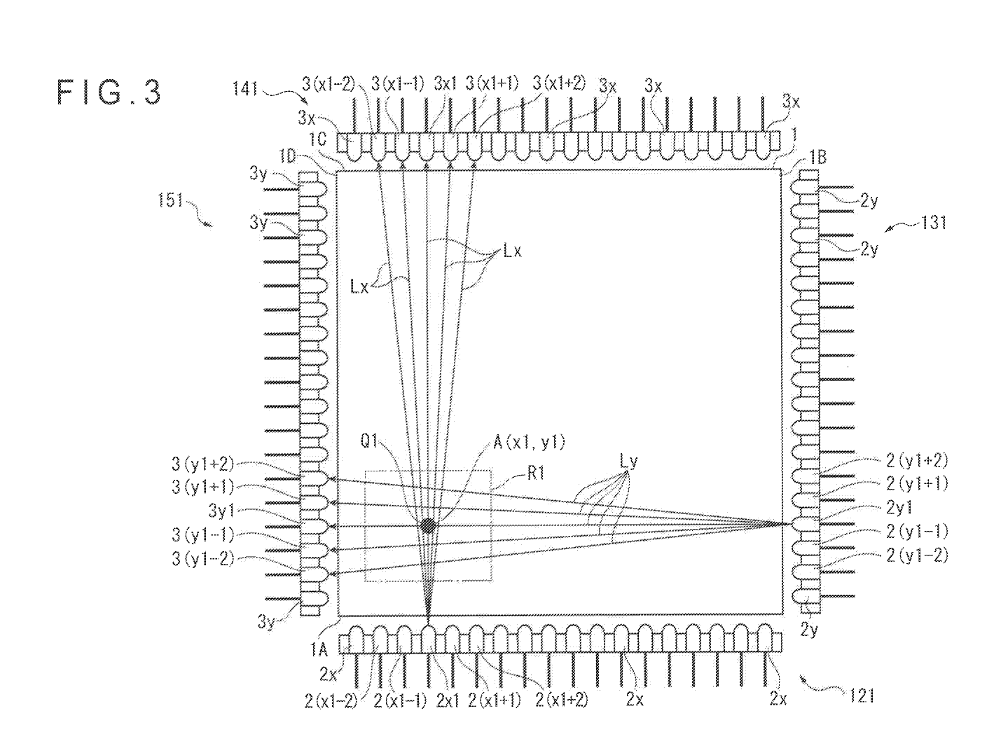

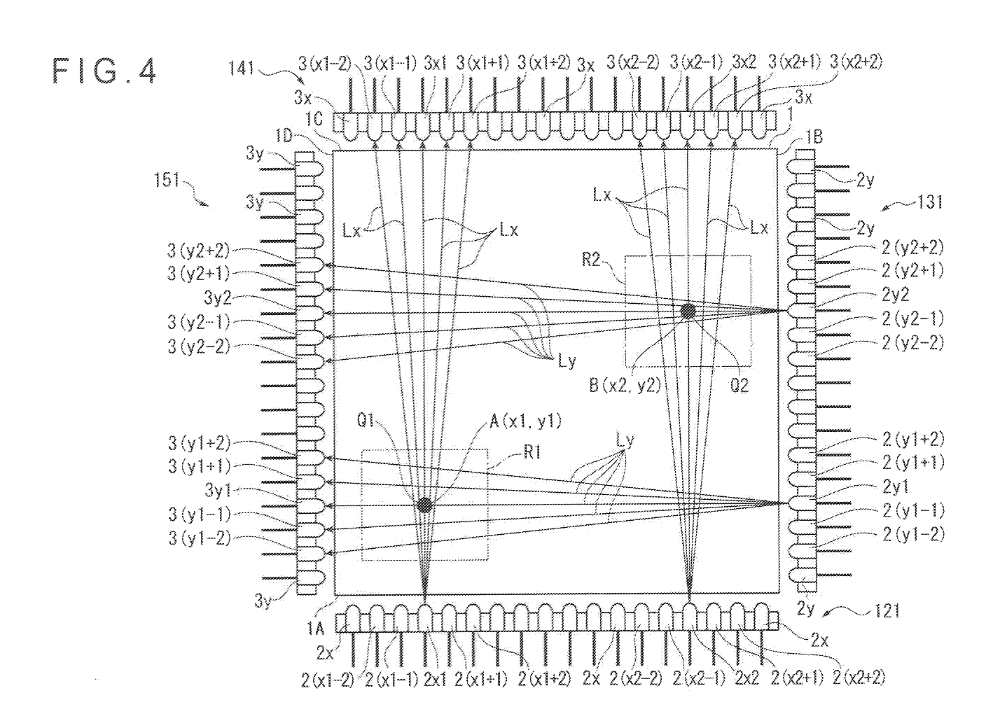

FIG. 1 is a block diagram schematically showing an arrangement of a display device according to first to third exemplary embodiments of the invention. FIG. 2 is an explanation view showing an entire simultaneous scanning process and an entire sequential scanning process. FIG. 3 is an explanation showing a first local simultaneous scanning process. FIG. 4 is an explanation view showing the first local simultaneous scanning process and a second local simultaneous process.

In FIG. 1, a display device 100, which is, for instance, an electronic blackboard device, detects the coordinate position of a portion light-blocked by at least one light-blocking object on a display surface and conducts a process corresponding to the detected coordinate position, e.g., displaying a dot at a position corresponding to the detected coordinate position.

The light-blocking object is herein exemplified by a dedicated stylus for the display device 100 or by a finger.

The display device 100 includes a display 110, an X-axis light-emitting unit 120, a Y axis light-emitting unit 130, an X-axis light-receiving unit 140, a Y-axis light-receiving unit 150, and a controller 160 serving as a coordinate position detecting device and a computer,

The display 110 includes a display surface 1 (a touch panel surface) and a display controller (not shown) that displays various images on the display surface 1 as needed.

As shown in FIG. 1, the display surface 1 is formed in a substantially rectangular shape having four sides. Specifically, the display surface 1 is formed in a substantially rectangular shape having a first side 1A, the second side 1B shorter than the first side 1A, a third side 1C being as long as the first side 1A, and a fourth side 1D being as long as the second side 1B, the first to fourth sides 1A to 1D being continuous along an outer circumferential direction of the display surface 1.

The X-axis light-emitting unit 120, which is disposed along the first side 1A, includes an X-axis light emitter 121 and an X-axis drive controller 122.

The X-axis light emitter 121, which is electrically connected to the X-axis drive controller 122, includes a plurality of (256, in this exemplary embodiment) light-emitting elements 2x arranged side by side along the first side 1A of the display surface 1 as shown in FIG. 2. The light-emitting elements 2x are infrared LEDs (Light-Emitting Diodes). It should be noted that the number of the light-emitting elements 2x shown in each of FIG. 2 and below-described FIGS. 3, 4 and 7 is smaller than the actual number thereof for simplification of illustration and the same applies to below-described light-emitting elements 2y and light-receiving elements 3x and 3y. It should also be noted that although, in the figures, reference signs 2x, 2y and 3x, 3y are attached to only some of the light-emitting elements and the light-receiving elements for convenience, it is not intended to specify the number of the light-emitting elements and the number of the light-receiving elements.

The X-axis drive controller 122 is electrically connected to the controller 160. Based on control by the controller 160, the X-axis drive controller 122 controls a selected one of the light-emitting elements 2x to emit an infrared detection light Lx toward the third side 1C along a planar direction of the display surface 1.

The Y-axis light-emitting unit 130, which is disposed along the second side 1B, includes a Y-axis light emitter 131 and a Y-axis drive controller 132.

The Y-axis light emitter 131, which is electrically connected to the Y-axis drive controller 132, includes light-emitting elements 2y arranged side by side along the second side 1A. The number of the light-emitting elements 2y is smaller than that of the light-emitting elements 2x. In this exemplary embodiment, the number of light-emitting elements 2y is 144. The light-emitting elements 2y are infrared LEDs.

The Y-axis drive controller 132 is electrically connected to the controller 160, and controls a selected one of the light-emitting elements 2y to emit an infrared detection light Ly toward the fourth side 1D along the planar direction of the display surface 1.

The X-axis light-receiving unit 140, which is disposed along the third side 1C, includes an X-axis light receiver 141, an X-axis output selector 142 and two X-axis AD converters 143,

The X-axis light receiver 141, which is electrically connected to the X-axis output selector 142, includes 256 light-receiving elements 3x arranged side by side along the third side 1C. The light-receiving elements 3x are opposed to the light-emitting elements 2x in a one-to-one manner. In other words, each of the light-receiving elements 3x is disposed at such a position as to receive the detection light Lx emitted from the opposed one of the light-emitting elements 2x. Each of the light-receiving elements 3x outputs to the X-axis output selector 142 a light-receiving signal corresponding to a light-receiving amount of the detection light Lx emitted from the opposed light-emitting element 2x.

The detection lights Lx are emitted in parallel with one another for an entire X-axis scanning process. Likewise, the detection lights Ly are emitted in parallel with one another for an entire Y-axis scanning process (describe later). Thus, the detection lights Lx for the entire X-axis scanning process and the detection lights Ly for the entire Y-axis scanning process are emitted in directions orthogonal to each other. It should be noted that although it is described that the detection lights Lx emitted for the entire X-axis scanning process and the detection lights Ly emitted for the entire Y-axis scanning process are orthogonal to each other, unless the detection lights Lx are parallel with one another and the detection lights Ly are parallel with one another, it is not necessary that the detection lights Lx and the detection lights Ly are orthogonal to each other.

The X-axis output selector 142 selectively acquires the light-receiving signals in an analog form from at most two of the light-receiving elements 3x every 0.1 ms (millisecond), and outputs these analog light-receiving signals to the two X-axis AD converters 143, respectively.

Each of the X-axis AD converters 143 converts the analog light-receiving signal into a digital light-receiving signal, and outputs the digital light-receiving signal to the controller 160.

The Y-axis light-receiving unit 150, which is disposed along the fourth side 1D, includes a Y-axis light receiver 151, a Y-axis output selector 152 and two Y-axis AD converters 153.

The Y-axis light receiver 151, which is electrically connected to the Y-axis output selector 152, includes 144 light-receiving elements 3y arranged side by side along the fourth side 11). The light-receiving elements 3y are opposed to the light-emitting elements 2y in a one-to-one manner. Each of the light-receiving elements 3y outputs to the Y-axis output selector 152 a light-receiving signal corresponding to a light-receiving amount of the detection light Ly emitted from the opposed one of the light-emitting elements 2y.

The Y-axis output selector 152 selectively acquires the light-receiving signals in an analog form from at most two of the light-receiving elements 3y every 0.1 ms, and outputs these analog light-receiving signals to the two Y-axis AD converters 153, respectively.

Each of the Y-axis AD converters 153 converts the analog light-receiving signal into a digital light-receiving signal, and outputs the digital light-receiving signal to the controller 160.

The controller 160, which is provided by various programs, includes a scanner 161 that scans a scanning area on the display surface 1 with the detection lights Lx and Ly, a coordinate detector 162 that detects the respective coordinate positions of first and second light-blocking objects Q1 and Q2 (see FIGS. 3 and 4) on the display surface 1, and a coordinate-corresponding processor 163.

The scanner 161 controls the X-axis light-emitting unit 120 and the Y-axis light-emitting unit 130 so that predetermined ones of the light-emitting elements 2x and 2y emit the detection lights Lx and Ly, respectively. In other words, the emission positions of the detection lights Lx and Ly are shifted along the first and second sides 1A and 1B, receptively.

Specifically; when the respective coordinate positions of the first and second light-blocking objects Q1 and Q2 are not detected by the coordinate detector 162, the scanner 161 conducts an entire simultaneous scanning process to sequentially scan the entire area of the display surface 1. When the coordinate position of one light-blocking object, i.e., the first light-blocking object Q1, is detected, the scanner 161 conducts an entire sequential scanning process to sequentially scan the entire area of the display surface 1. In other words, in the exemplary embodiment, a preset reference number is set at two, so that when the number of the light-blocking objects, the coordinate positions of which are detected, is less than two, the scanner 161 conducts the entire simultaneous scanning process or the entire sequential scanning process.

In the entire simultaneous scanning process, the scanner 161 simultaneously conducts the entire X-axis scanning process, in which the detection lights Lx are sequentially emitted from all the light-emitting elements 2x for scanning, and the entire Y-axis scanning process, in which the detection lights Ly are sequentially emitted from all the light-emitting elements 2y for scanning.

Specifically, for the entire X-axis scanning process, the scanner 161 sequentially activates the light-emitting elements 2x one by one in order from the light-emitting element 2x closest to the fourth side 1D to emit the detection light Lx every 0.1 ms. As shown in FIG. 2, the scanner 161 also activates the X-axis output selector 142 to receive a reception signal every 0.1 ms only from the light-receiving element 3x opposed to the light-emitting element 2x that has emitted the detection light Lx. The scanner 161 then acquires a digital light-receiving signal via one of the X-axis AD converters 143, and outputs the light-receiving signal to the coordinate detector 162 along with an emission position signal relating to the position of the light-emitting element 2x that has emitted the detection light Lx.

For the entire Y-axis scanning process, the scanner 161 sequentially activates the light-emitting elements 2y one by one in order from the light-emitting element 2y closest to the third side 1C to emit the detection light Ly every 0.1 ms, and activates the Y-axis output selector 152 to receive a reception signal only from the light-receiving element 3y opposed to the light-emitting element 2y that has emitted the detection light Ly every 0.1 ms. The scanner 161 then acquires a digital light-receiving signal via one of the Y-axis AD converters 153, and outputs the light-receiving signal to the coordinate detector 162 along with an emission position signal relating to the position of the light-emitting element 2y that has emitted the detection light Ly.

Since the 256 light-emitting elements 2x exist, time required for one cycle of the entire X-axis scanning process (hereinafter referred to as “entire X-axis scanning time”) is 25.6 ms. Since the 144 light-emitting elements 2y exist, time required for one cycle of the entire Y-axis scanning process (hereinafter referred to as “entire Y-axis scanning time”) is 14.4 ms. In order to synchronize the entire X-axis scanning process with the entire Y-axis scanning process, even after the entire Y-axis scanning process is completed, the scanner 161 does not conduct another cycle of the entire Y-axis scanning process until the ongoing cycle of the entire X-axis scanning process is completed. Thus, a scanning time for one cycle of an entire scanning process, i.e., time required for one cycle of the entire simultaneous scanning process (hereinafter referred to as “entire simultaneous scanning time”), is 25.6 ms.

In contrast, in the entire sequential scanning process, the scanner 161 sequentially conducts the entire X-axis scanning process and the entire Y-axis scanning process.

Since the entire X-axis scanning time and the entire Y-axis scanning time are 25.6 ms and 14.4 ms, respectively; a scanning time for one cycle of the entire scanning process, i.e., time required for the entire sequential scanning process (hereinafter referred to as “entire sequential scanning time”), is 40 ms.

With the above control, the entirety of the display surface 1 is sequentially scanned.

When the coordinate position of one light-blocking object, i.e., the first light-blocking object Q1, is detected, the entire simultaneous scanning process may be conducted.

As shown in FIG. 3, when the coordinate position of the one light-blocking object, i.e., the first light-blocking object Q1, is detected, the scanner 161 conducts a first local simultaneous scanning process (an oblique-part scanning process) and the entire sequential scanning process in parallel. In the first local simultaneous scanning process, the detection lights Lx and Ly are concentrically emitted for scanning the vicinity of the first light-blocking object Q1, i.e., a local area R1 including the first light-blocking object Q1 on the display surface I. The first local simultaneous scanning process is preferably conducted at least twice while the entire sequential scanning process is conducted once,

Specifically, in the first local simultaneous scanning process, the scanner 161 simultaneously conducts a local X-axis scanning process, in which the detection lights Lx are sequentially emitted from ones of the light-emitting elements 2x corresponding to the local area R1 for scanning, and a local Y-axis scanning process, in which the detection lights Ly are sequentially emitted from ones of the light-emitting elements 2y corresponding to the local area R1 for scanning.

When the coordinate position of the first light-blocking object Q1 is (x1, y1), the scanner 161 specifies the following light-emitting elements as emission target elements: a light-emitting element 2x1 having an X-coordinate of x1 and two on each side thereof (i.e., light-emitting elements 2(x1+1), 2(x1+2), 2(x1−1) and 2(x1−2)) and a light-emitting element 2y1 having a Y-coordinate of y1 and two on each side thereof (i.e., light-emitting elements 2(y1+1), 2(y1+2), 2(y1−1) and 2(y1−2)).

For the local X-axis scanning process, the scanner 161, for instance, activates the light-emitting elements 2(x1+1), 2(x1+2), 2x1, 2(x1−1) and 2(x1−2) one by one in this order to emit the detection light Lx every 0.5 ms. The scanner 161 outputs to the coordinate detector 162 respective reception signals received from five of the light-receiving elements 3x corresponding to these light-emitting elements 2x.

For instance, the detection light Lx is emitted from the light-emitting element 2x1 with a predetermined spread, so that not only a light-receiving element 3x1 opposed to the light-emitting element 2x1 but also light-receiving elements 3(x1+1), 3(x1+2), 3(x1−1) and 3(x1−2) around the light-receiving element 3x1 can receive this light. Thus, for the local X-axis scanning process, the detection lights Lx are emitted not only in parallel with one another in a direction from the light-emitting elements 2x toward the light-receiving elements 3x but also in an oblique direction, for instance, from the light-emitting element 2x1 toward the light-receiving element 3(x1+1).

The scanner 161 activates the X-axis output selector 142 to sequentially acquire reception signals only from the light-receiving elements 3(x1+2), 3(x1+1), 3x1, 3(x1−1) and 3(x1−2) every 0.1 ms, and acquires a digital light-receiving signal via one of the X-axis AD converters 143. The scanner 161 outputs the light-receiving signal to the coordinate detector 162 along with an emission position signal relating to the position of the light-emitting element 2x that has emitted the detection light Lx.

For the local Y-axis scanning process, the scanner 161 activates the light-emitting elements 2(y1+1), 2(y1+2), 2y1, 2(y1−1) and 2(y1−2) one by one in this order to emit the detection light Ly every 0.5 ms, and outputs to the coordinate detector 162 respective reception signals received from five of the light-receiving elements 3y corresponding to these light-emitting elements 2y.

For the local Y-axis scanning process, the detection lights Ly are emitted not only in parallel with one another but also in the obliquely intersecting directions in the same manner as the detection lights Lx for the local X-axis scanning process.

In other words, the detection lights Lx for the local X-axis scanning process and the detection lights Ly for the local Y-axis scanning process are emitted not only in directions orthogonal to each other but also in the obliquely intersecting directions.

For instance, the scanner 161 activates the light-emitting element 2y1 to emit the detection light Ly, and activates the Y-axis output selector 152 to receive reception signals only from the light-receiving elements 3(y1+2), 3(y1+1), 3y1, 3(y1−1) and 3(y1−2) every 0.1 ms. The scanner 161 then outputs a digital light-receiving signal via one of the Y-axis Al) converters 153 to the coordinate detector 162 along with an emission position signal relating to the position of the light-emitting element 2y that has emitted the detection light Lx.

Five of the light-emitting elements 2x are emitted in turn every 0.5 ms in one cycle of the local X-axis scanning process while five of light-emitting elements 2y are emitted in turn every 0.5 ms in one cycle of the local Y-axis scanning process. Thus, time required for one cycle of the local X-axis scanning process (hereinafter referred to as “local X-axis scanning time”) and time required for one cycle of the local Y-axis scanning process (hereinafter referred to as “local Y-axis scanning time”) are 2.5 ms each. Thus, a scanning time for one cycle of the oblique-part scanning process, i.e., time required for one cycle of the first local simultaneous scanning process (hereinafter referred to as “first local simultaneous scanning time”), is 2.5 ms.

In other words, since the first local simultaneous scanning time is one sixteenth of the entire sequential scanning time, the scanner 161 conducts the first local simultaneous scanning process for 16 times while conducting the entire sequential scanning once. Since simultaneously conducting the entire scanning and the first local simultaneous scanning for a coordinate point may lead to malfunction, it is necessary to consider a timing so as not to simultaneously conduct the entire scanning and the first local simultaneous scanning for a coordinate point. In view of the above, it is preferable that the scanner 161 conducts the first local simultaneous scanning and the entire sequential scanning in synchronization,

The coordinate position of the second light-blocking object Q2 may be detected when the scanner 161 conducts the first local simultaneous scanning process and the entire sequential scanning process in parallel. In this case, as shown in FIG. 4, while continuing the first local simultaneous scanning process for the first light-blocking object Q1, the scanner 161 conducts a second local simultaneous scanning process in parallel. In the second local simultaneous scanning process, the detection lights Lx and Ly are concentrically emitted for scanning the vicinity of the second light-blocking object Q2, i.e., a local area R2. The scanner 161 also terminates the entire sequential scanning process.

In other words, the scanner 161 simultaneously conducts the local X-axis scanning process and the local Y-axis scanning process for the first light-blocking object Q1 and conducts the local X-axis scanning process and the local Y-axis scanning process for the second light-blocking object Q2.

Specifically, when the coordinate position of the second light-blocking object Q2 is (x2, y2), light-emitting elements 2x2, 2(x2+1), 2(x2+2), 2(x2−1) and 2(x2−2) and light-emitting elements 2y2, 2(y2+1), 2(y2+2), 2(y2−1) and 2(y2−2) are specified as emission target elements by the scanner 161 in the same manner as in the first local simultaneous scanning process. The scanner 161 simultaneously conducts the local X-axis scanning process and the local Y-axis scanning process, so that the detection lights Lx and Ly are emitted from the emission target elements in turn every 0.5 ms and light-receiving signals are outputted from five of the light-receiving elements 3x corresponding to each of the emission target elements to the X-axis output selector 142 and the Y-axis output selector 152 every 0.1 ms.

In this exemplary embodiment, when the first and second light-blocking objects Q1 and Q2 are detected, the second local simultaneous scanning process is started in place of the entire sequential scanning process. Since the X-axis and Y-axis Al) converters 143 and 153, which were used for the entire sequential scanning process, can be used for the second local simultaneous scanning process, the first and second local simultaneous scanning processes for the first and second light-blocking objects Q1 and Q2 can be simultaneously conducted.

Since the first and second local simultaneous scanning processes for the first and second light-blocking objects Q1 and Q2 are simultaneously conducted, time required for one cycle of the first and second local simultaneous scanning is 2.5 ms.

Table 1 shows the scanning time of each scanning process.

TABLE 1

| | | The Number of Light-Blocking Objects | | |
|---|---|---|---|---|
| | | 0 | 1 | 2 |
| Entire | Scanning | Entire | Entire | — |
| Scanning | Detail | Simultaneous | Sequential | |
| | Time | 25.6 ms | 40 ms | — |
| | Required | | | |
| Local | Scanning | — | 1st Local | Simultaneously |
| Scanning | Detail | | Simultaneous | Conduct 1st |
| | | | | Local Simulta- |
| | | | | neous and |
| | | | | 2nd Local |
| | | | | Simultaneous |
| | Time | — | 2.5 ms | 2.5 ms |
| | Required | | | |

When the coordinate detector 162 detects that the first and second light-blocking objects Q1 and Q2 block the detection lights Lx and Ly during the entire simultaneous scanning process, the entire sequential scanning process, the first local simultaneous scanning process or the second local simultaneous scanning process, the coordinate detector 162 detects the respective coordinate positions of the first and second light-blocking objects Q1 and Q2. A detailed operation of the coordinate detector 162 will be described later.

The coordinate-corresponding processor 163 conducts a process corresponding to the coordinates detected by the coordinate detector 162, e.g., a process of displaying a dot.

### Operation of Display Device

Next, the operation of the display device 100 will be described.

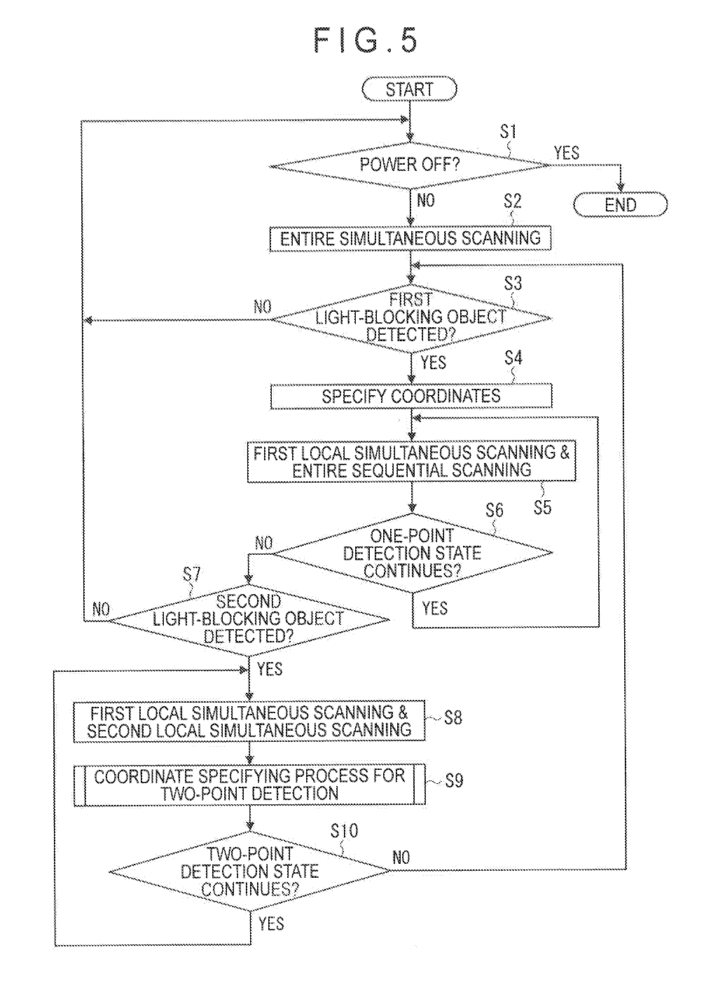

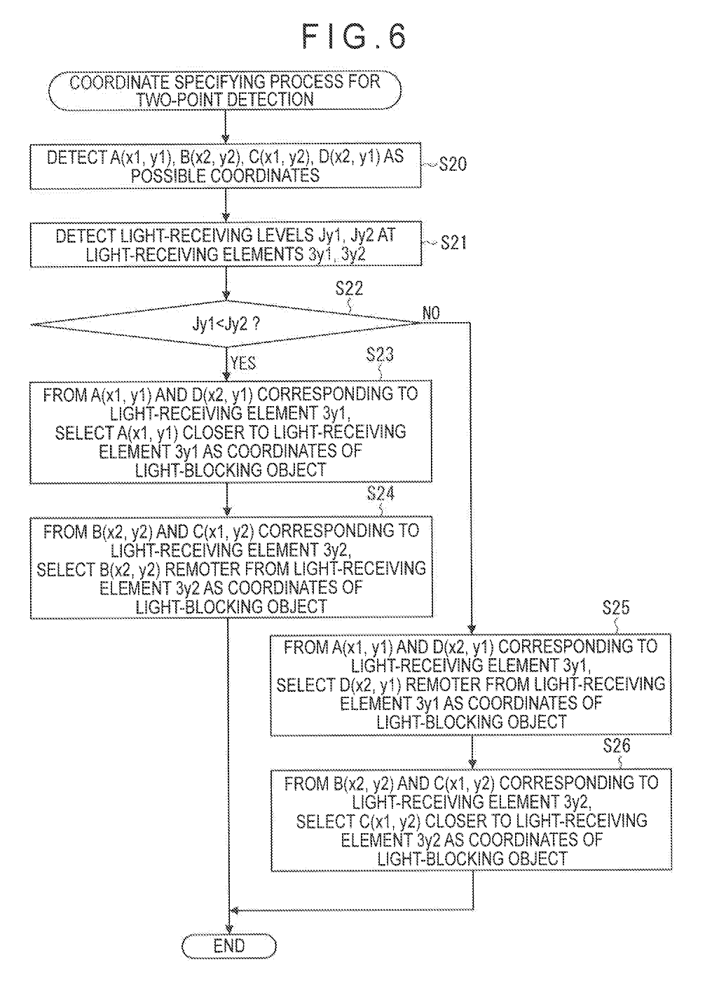

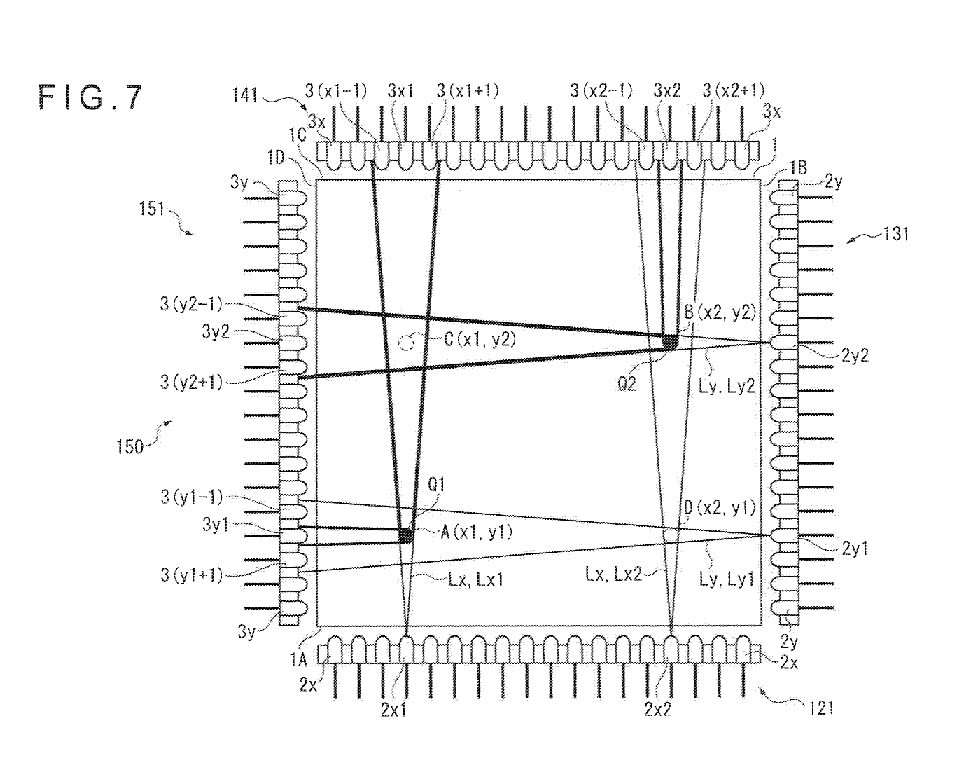

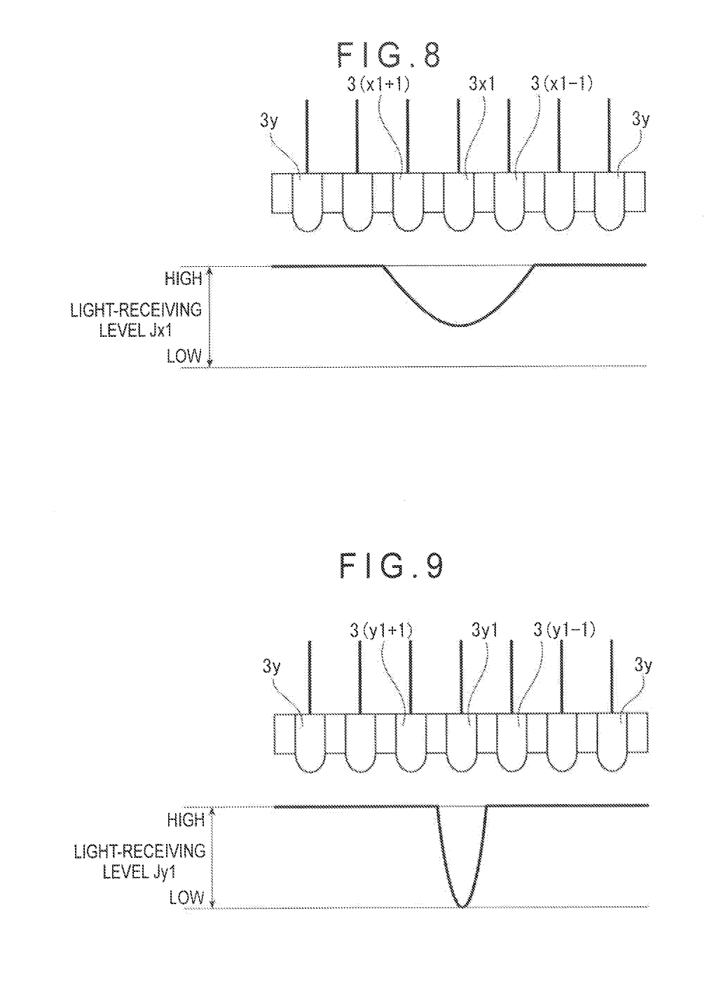

FIG. 5 is a flowchart showing a coordinate detecting process. FIG. 6 is a flowchart showing a coordinate specifying process for two-point detection. FIG. 7 schematically shows a light-blocked state with the presence of two light-blocking objects. FIG. 8 schematically shows a light-receiving level at the time when light is blocked at a position distant from the light-receiving elements. FIG. 9 schematically shows a light-receiving level at the time when light is blocked at a position close to the light-receiving elements.

As shown in FIG. 5, when the display device 100 is in a power-on state, the scanner 161 of the display device 100 judges whether or not the power is turned of (step S1). When recognizing that the power is turned off, the scanner 161 ends the process. On the other hand, when judging that the power is still on in step S1, the scanner 161 conducts the entire simultaneous scanning process for scanning the entirety of the display surface 1 as shown in FIG. 2 (step S2). Subsequently, the coordinate detector 162 judges whether or not the first light-blocking object Q1 is detected (step S3).

When the coordinate detector 162 judges that the first light-blocking object Q1 is not detected because the respective light-receiving levels of all the light-receiving elements 3x and 3y are not changed in step S3, the process returns to step S1. On the other hand, when the coordinate detector 162 judges that the first light-blocking object Q1 as shown in FIG. 3 is detected based on a change in the respective light-receiving levels of the predetermined light-receiving elements 3x1 and 3y1 in step S3, the coordinate detector 162 specifies coordinates A(x1, y1), which correspond to the light-receiving elements 3x1 and 3y1, as coordinates of the first light-blocking object Q1 (step S4).

When the coordinate detector 162 detects the coordinates A(x1, y1) of the first light-blocking object Q1, the scanner 161 conducts the entire sequential scanning process for scanning the entirety of the display surface 1 as shown in FIG. 2 and the first local simultaneous scanning process for scanning only the local area R1 as shown in FIG. 3 in parallel (step S5). During the process of step S5, the coordinate detector 162 continuously detects the coordinates of the first light-blocking object Q1 based on a light-blocked state provided by the first local simultaneous scanning process. The coordinate-corresponding processor 163 conducts a process corresponding to the coordinates of the first light-blocking object Q1, e.g., a process of drawing a line on the locus of the first light-blocking object Q1.

In step S5, the scanner 161 conducts the first local simultaneous scanning for 16 times while conducting the entire sequential scanning once.

Subsequently, the scanner 161 judges whether or not a one-point detection state, in which only the first light-blocking object Q1 is still detected, is still going on (step S6). When the one-point detection state is still going on, the scanner 161 conducts the process of step S5. On the other hand, when the one-point detection state is not going on in step S6, the scanner 161 judges whether or not the second light-blocking object Q2 is detected (step S7).

When the scanner 161 judges in step S7 that the second light-blocking object Q2 is not detected, i.e., the first light-blocking object Q1 disappears from the display surface 1, the process returns to step S1. When the scanner 161 judges in step S7 that the second light-blocking object Q2 is detected, the scanner 161 terminates the entire sequential scanning process, and simultaneously conducts the second local simultaneous scanning process for the second light-blocking object Q2 and the first local simultaneous scanning process (step S8). Specifically, as shown in FIG. 4, when the respective light-receiving levels of other light-receiving elements, i.e., light-receiving elements 3x2 and 3y2, are newly changed in the entire sequential scanning process, the local area R2 is specified. The scanner 161 specifies five of the light-emitting elements 2x and five of the light-emitting elements 2y corresponding to the local area R2 as the emission target elements. and starts the second local simultaneous scanning process using the detection lights Lx and Ly emitted from the specified light-emitting elements 2x and 2y in place of the entire sequential scanning process.

The coordinate detector 162 conducts the coordinate specifying process for two-point detection for specifying the respective coordinates of the first and second light-blocking objects Q1 and Q2 (step S9).

The coordinate detector 162 continuously detects the respective coordinates of the first and second light-blocking objects Q1 and Q2 based on a light-blocked state provided by the first and second local simultaneous scanning processes. The coordinate-corresponding processor 163 conducts a process corresponding to the respective coordinates of the first and second light-blocking objects Q1 and Q2. The scanner 161 judges whether or not a two-point detection state, in which the first and second light-blocking objects Q1 and Q2 keep on being detected, is still going on (step 510). If going on, the process returns to step S8. If not, the process returns to step S3.

As shown in FIG. 6, in the coordinate specifying process for two-point detection in step 59, when the first and second light-blocking objects Q1 and Q2 exist at coordinates A(x1, y1) and B(x2, y2), respectively, as shown in Fig, 7, the coordinate detector 162 realizes a decrease in the respective light-receiving levels of the light-receiving elements 3x1, 3(x1+1), 3(x1−1), 3y1, 3(y1+1) and 3(y1−1) resulting from light interception of the first light-blocking object Q1 and a decrease in the respective light-receiving levels of the light-receiving elements 3x2, 3(x2+1), 3(x2−1), 3y2, 3(y2+1) and 3(y2−1) resulting from light interception of the second light-blocking object Q2. Based on these decreases in the light-receiving levels, the coordinate detector 162 detects coordinates A(x1, y1), B(x2, y2), C(x1, y2) and D(x2, y1) as possible coordinates at which the first and second light-blocking objects Q1 and Q2 are supposed to exist (step S20).

When the first light-blocking object Q1 exists at a position distant from the light-receiving elements 3x but close to the light-receiving elements 3y as shown in FIG. 7, a detection light Lx1 is blocked at a position distant from the light-receiving element 3x1, so that a decrease of a light-receiving level Jx1 of the light-receiving element 3x1 is small as shown in FIG. 8. Further, since the detection light Ly1 is blocked at a position close to the light-receiving element 3y1, a decrease in a light-receiving level Jy1 of the light-receiving element 3y1 is large.

This is because when light is blocked at a position distant from the light-receiving elements 3x or 3y, the detection light Lx or Ly is largely diverted to travel between the first light-blocking object Q1 and the light-receiving elements 3x or 3y, which results in a small decrease in the light-receiving level Jx or Jy, while when light is blocked at a position close to the light-receiving elements 3x or 3y, the diversion of the detection light Lx or Ly is small, which results in a large decrease in the light-receiving level Jx or Jy.

In consideration of the above phenomenon, the coordinate detector 162 detects the respective coordinates of the first and second light-blocking objects Q1 and Q2 after the process of step S20.

Specifically, the coordinate detector 162 detects the light-receiving levels Jy1 and Jy2 of the light-receiving elements 3y1 and 3y2 (step S21), and judges whether or not the light-receiving level Jy1 is lower than the light-receiving level Jy2 (step S22).

When the light-receiving level Jy1 is lower in step 522, comparing the coordinates A(x1, y1) and D(x2, y1) corresponding to the light-receiving element 3y1, the coordinate detector 162 selects the coordinates A(x1, y1) as the coordinates of the first light-blocking object Q1 because the coordinates A(x1, y1) is closer to the light-receiving element 3y1 (step S23). Further, comparing the coordinates B(x2, y2) and C(x1, y2) corresponding to the light-receiving element 3y2, the coordinate detector 162 selects the coordinates B(x2, y2) as the coordinates of the second light-blocking object Q2 because the coordinates B(x2, y2) is remoter from the light-receiving element 3y2 (step S24). The coordinate specifying process for two-point detection is then completed.

On the other hand, when the light-receiving level Jy2 is lower in step S22, comparing the coordinates A(x1, y1) and D(x2, y1) corresponding to the light-receiving element 3y1, the coordinate detector 162 selects the coordinates D(x2, y1) as the coordinates of the first light-blocking object Q1 because the coordinates D(x2, y1) is remoter from the light-receiving element 3y1 (step S25). Further, comparing the coordinates B(x2, y2) and C(x1, y2) corresponding to the light-receiving element 3y2, the coordinate detector 162 selects the coordinates C(x1, y2) as the coordinates of the second light-blocking object Q2 because the coordinates C(x1, y2) is closer to the light-receiving element 3y2 (step S26). The coordinate specifying process for two-point detection is then completed.

### Advantages of First Exemplary Embodiment

### The Above First Exemplary Embodiment can Achieve the Following Advantages.

(1) When the coordinate detector 162 detects the first light-blocking object Q1, the scanner 161 of the controller 160 conducts the first local simultaneous scanning process for scanning the local area R1 including the first light-blocking object Q1 and the entire sequential scanning process.

Thus, after the detection of the coordinates of the first light-blocking object Q1, only the vicinity of the first light-blocking object Q1 is scanned by the first local simultaneous scanning process, so that the coordinates of the first light-blocking object Q1 can be detected with a high responsiveness. Further, even after the detection of the coordinates of the first light-blocking object Q1, the entirety of the display surface 1 is scanned by the entire sequential scanning process, so that the coordinates of the second light-blocking object Q2 can also be reliably detected simultaneously with detection of the coordinates of the first light-blocking object Q1.

(2) A predetermined area is scanned in a so-called infrared blocking method according to which the infrared detection lights Lx and Ly emitted from the light-emitting elements 2x and 2y are received by the light-receiving elements 3x and 3y, respectively. Thus, the respective coordinates of the first and second light-blocking objects Q1 and Q2 can be easily detected by scanning the predetermined area with a simple arrangement. Additionally, since the detection lights Lx for the entire X-axis scanning process and the detection lights Ly for the entire Y-axis scanning process are not emitted in the directions obliquely intersecting with each other, the display device 100 can be structurally simplified to improve manufacturing efficiency. Although it is preferable that the detection lights Lx and Ly orthogonally intersect with each other, the orthogonal intersection is not necessary as long as the detection lights Lx and Ly intersect with each other.

(3) Based on a decrease in the respective light-receiving levels of the light-receiving elements 3x1, 3x2, 3y1 and 3y2, the coordinate detector 162 of the controller 160 recognizes the coordinates A(x1, y1), B(x2, y2), C(x1, y2) and D(x2, y1) as the possible coordinates at which the first and second light-blocking objects Q1 and Q2 are supposed to exist. Based on a magnitude relation between the light-receiving levels Jy1 and Jy2 of the light-receiving elements 3y1 and 3y2, the coordinate detector 162 detects the respective coordinates of the first and second light-blocking objects Q1 and Q2.

Thus, by simply comparing the light-receiving levels Jy1 and Jy2 of the light-receiving elements 3y1 and 3y2 to each other, the respective coordinates of the first and second light-blocking objects Q1 and Q2 can be reliably detected.

(4) When the first local simultaneous scanning process and the entire sequential scanning process are conducted in parallel and the second light-blocking object Q2 is detected by the entire sequential scanning process, the second local simultaneous scanning process tier scanning the local area R2 including the second light-blocking object Q2 is conducted along with the first local simultaneous scanning process and the entire simultaneous scanning process is terminated.

Thus, after the detection of the coordinates of the second light-blocking object Q2, only the vicinity of the second light-blocking object Q2 is scanned to detect the coordinates thereof, so that the coordinates of the second light-blocking object Q2 can be detected with a high responsiveness. Further, since the entire sequential scanning process is terminated after the detection of the respective coordinates of the two (which is preset number) first and second light-blocking objects Q1 and Q2, a processing load can be reduced.

(5) The scanner 161 of the controller 160 conducts the first local simultaneous scanning process for 16 times while conducting the entire sequential scanning once. Thus, the first local simultaneous scanning process can be conducted at a higher speed than the entire sequential scanning.

(6) A timing is considered so as not to simultaneously conduct the entire scanning and the first local simultaneous scanning for a coordinate point, thereby avoiding malfunction. It is preferable that the scanner 161 conducts the first local simultaneous scanning and the entire sequential scanning in synchronization. With the above arrangement, it is easy to prevent the entire scanning and the first local simultaneous scanning from being simultaneously conducted for a coordinate point. Thus, for conducting the first local simultaneous scanning process at a higher speed than the entire sequential scanning and for easily preventing the entire scanning and the first simultaneous scanning for a coordinate point from being simultaneously conducted, it is preferable that the scanning time of the first local simultaneous scanning process is one half of that of the entire sequential scanning process or less. It should be noted that an arrangement in which N times of the entire scanning are synchronized with M times of the second local scanning (each of N and M is an integer) can also easily prevent the entire scanning and the first local simultaneous scanning for a coordinate point from being simultaneously conducted.

(7) When the coordinate position of the first light-blocking object Q1 is detected, the scanner 161 of the controller 160 switches the entire simultaneous scanning process, in which the local X-axis scanning process and the local Y-axis scanning process are simultaneously conducted, to the entire sequential scanning process, in which the local X-axis scanning process and the local Y-axis scanning process are sequentially conducted. Thus, when the first local simultaneous scanning process is newly started for the first light-blocking object Q1, a processing load can be reduced as compared with an arrangement in which the entire simultaneous scanning process is continued.

(8) For the light-blocking object Q1, the scanner 161 of the controller 160 allows the detection light Lx for the local X-axis scanning process and the detection light Ly for the local Y-axis scanning process to be emitted in the directions orthogonal to each other and in the directions obliquely intersecting with each other.

Thus, the vicinity of the first light-blocking object Q1 can be closely scanned, thereby accurately detecting the coordinate position of the first light-blocking object Q1.

### Second Exemplary Embodiment

Next, a second exemplary embodiment of the invention will be described,

As shown in FIG. 1, a display device 100A according to the second exemplary embodiment is different from the display device 100 according to the first exemplary embodiment in the processing details of a scanner 161A of a controller 160A.

Specifically, as shown in Table 2 below, when one light-blocking object is detected, the scanner 161A simultaneously conducts the entire sequential scanning process and a first local sequential scanning process, in which the local X-axis scanning process and the local Y-axis scanning process are sequentially conducted.

When two light-blocking objects are detected, after terminating the entire sequential scanning process, the scanner 161A simultaneously conducts the first local sequential scanning process for one of the light-blocking objects and a second local sequential scanning process for the other light-blocking object (the local X-axis scanning process and the local Y-axis scanning process are sequentially conducted).

TABLE 2

| | | The Number of Light-Blocking Objects | | |
|---|---|---|---|---|
| | | 0 | 1 | 2 |
| Entire | Scanning | Entire | Entire | — |
| Scanning | Detail | Simultaneous | Sequential | |
| | Time | 25.6 ms | 40.0 ms | — |
| | Required | | | |
| Local | Scanning | — | 1st Local | Simultaneously |
| Scanning | Detail | | Sequential | Conduct 1st |
| | | | | Local Sequential |
| | | | | and 2nd Local |
| | | | | Sequential |
| | Time | — | 5.0 ms | 5.0 ms |
| | Required | | | |

One cycle of the local X-axis scanning and one cycle of the local Y-axis scanning each take 2.5 ms, so that time required for one cycle of the first local sequential scanning process (hereinafter referred to as “first local sequential scanning time”) is 5.0 ms. When the first and second local simultaneous scanning processes are simultaneously conducted, time required therefor is 5.0 ms.

### Advantages of Second Exemplary Embodiment

The above second exemplary embodiment can achieve the following advantages in addition to the advantages (1) to (9) of the first exemplary embodiment.

(10) When one light-blocking object is detected, the scanner 161A of the controller 160A conducts the first local sequential scanning process, and when two light-blocking objects are detected, the scanner 161A simultaneously conducts the first and second local sequential scanning processes.

Thus, when one light-blocking object is detected, a processing load can be reduced as compared with the arrangement according to the first exemplary embodiment in which the first local simultaneous process is conducted. When two light-blocking objects are detected, a processing load can be reduced as compared with the arrangement according to the first exemplary embodiment in which the first and second local simultaneous processes are simultaneously conducted.

### Third Exemplary Embodiment

Next, a third exemplary embodiment of the invention will be described.

As shown in FIG. 1, a display device 100B according to the third exemplary embodiment is different from the display device 100A according to the second exemplary embodiment in that the reference number is three and in the processing details after detection of the second and third light-blocking objects.

Specifically, as shown in Table 3 below; when two light-blocking objects are detected, a scanner 161B of a controller 160B conducts the entire sequential scanning process while sequentially conducting the first and second local sequential scanning processes for the two light-blocking objects.

When three light-blocking objects are detected, after terminating the entire sequential scanning process, the scanner 161B sequentially conducts the first local simultaneous scanning process, the second local simultaneous scanning process and a third local simultaneous scanning process for each of the light-blocking objects. The third local simultaneous scanning process is a process in which the local X-axis scanning process and the local Y-axis scanning process are simultaneously conducted for the third light-blocking object.

TABLE 3

| | | The Number of Light-Blocking Objects | | | |
|---|---|---|---|---|---|
| | | 0 | 1 | 2 | 3 |
| Entire | Scanning | Entire | Entire | Entire | — |
| Scanning | Detail | Simultaneous | Sequential | Sequential | |
| | Time | 25.6 ms | 40.0 ms | 40.0 ms | — |
| | Required | | | | |
| Local | Scanning | — | 1st Local | Sequentially Conduct | Sequentially Conduct |
| Scanning | Detail | | Sequential | 1st Local Sequential and | 1st Local Simultaneous, |
| | | | | 2nd Local Sequential | 2nd Local Simultaneous and |
| | | | | | 3rd Local Simultaneous |
| | Time | — | 5.0 ms | 10.0 ms | 7.5 ms |
| | Required | | | | |

Time required for the local scanning conducted when two light-blocking objects are detected is 10.0 ms. Time required for the local scanning conducted when three light-blocking objects are detected is 7.5 ms.

### Advantages of Third Exemplary Embodiment

The above third exemplary embodiment can achieve the following advantages in addition to the advantages (2), (3), (6), (8) and (9) of the first exemplary embodiment.

(11) When three light-blocking objects are detected, the scanner 161B of the controller 160B sequentially conducts the first to third local simultaneous scanning processes. Thus, even when the three light-blocking objects are detected, the advantage (1) of the first exemplary embodiment can also be achieved.

### Fourth Exemplary Embodiment

Next, a fourth exemplary embodiment of the invention will be described.

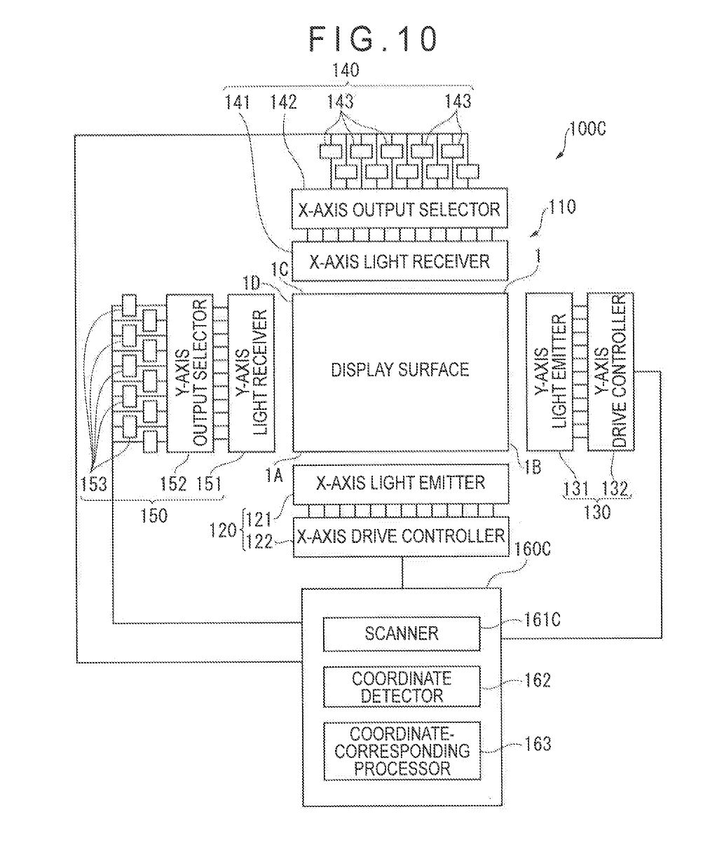

FIG. 10 is a block diagram schematically showing an arrangement of a display device according to the fourth exemplary embodiment of the invention.

A display device 100C according to the fourth exemplary embodiment is different from the display device 100A according to the second exemplary embodiment in that the display device 100C is provided with ten X-axis converters 143 and ten Y-axis AD converters 153 and in the process details of a scanner 161C of a controller 160C.

Specifically, as shown in Table 4 below, when one light-blocking object is detected, the scanner 161C conducts the entire sequential scanning process while conducting the first local sequential scanning process for this light-blocking object (i.e., the first light-blocking object).

TABLE 4

| | | The Number of Light-Blocking Objects | | |
|---|---|---|---|---|
| | | 0 | 1 | 2 |
| Entire | Scanning | Entire | Entire | — |
| Scanning | Detail | Simultaneous | Sequential | |
| | Time | 25.6 ms | 40.0 ms | — |
| | Required | | | |
| Local | Scanning | — | 1st Local | Simultaneously |
| Scanning | Detail | | Sequential | Conduct 1st |
| | | | | Local Simulta- |
| | | | | neous and |
| | | | | 2nd Local |
| | | | | Simultaneous |
| | Time | — | 1.0 ms | 0.5 ms |
| | Required | | | |

In the local X-axis scanning process of the first local sequential scanning process according to the fourth exemplary embodiment, for instance, the scanner 161C activates the light-emitting element 2x1 to emit the detection light Lx only for 0.1 ms. The scanner 161C activates the X-axis output selector 142 to simultaneously acquire reception signals only from the light-receiving elements 3(x1+2), 3(x1+1), 3x1, 3(x1−1) and 3(x1−2), and simultaneously acquires digital light-receiving signals via five of the X-axis AD converters 143. The scanner 161 outputs these light-receiving signals to the coordinate detector 162 along with an emission position signal relating to the position of the light-emitting element 2x that has emitted the detection light Lx.

Likewise, in the local Y-axis scanning process, the scanner 161C activates the light-emitting element 2y1 to emit the detection light Ly only for 0.1 ms, and outputs light-receiving signals simultaneously acquired via five of the Y-axis AD converters 153 to the coordinate detector 162, in the same manner as in the local X-axis scanning process.

Since five of the light-emitting elements 2x each emit the detection light Lx for 0.1 ms, time required for the local X-axis scanning process is 0.5 ms. Likewise, since five of the light-emitting elements 2y each emit the detection light Ly for 0.1 ms, time required for the local Y-axis scanning process is 0.5 ms. Thus, time required for the first local sequential scanning process, in which the local X-axis and Y-axis scanning processes are sequentially conducted, is 1.0 ms and time required for the first local simultaneous scanning process, in which the local X-axis and Y-axis scanning processes are simultaneously conducted, is 0.5 ms. When two light-blocking objects are detected, the scanner 161C also activates the light-emitting elements 2x2 and 2y2 to emit the detection lights Lx and Ly only for 0.1 ms, respectively, and outputs light-receiving signals simultaneously acquired via five of the X-axis AD converters 143 and five of the Y-axis AD converters 153 to the coordinate detector 162. Since the first and second local simultaneous scanning processes are simultaneously conducted, time required therefor is 0.5 ms.

### Advantages of Fourth Exemplary Embodiment

The above fourth exemplary embodiment can achieve the following advantages in addition to the advantages (1) to (9) of the first exemplary embodiment,

(12) The arrangement according to this exemplary embodiment uses the ten X-axis AD converters 143 and the ten Y-axis AD converters 153. Thus, when one of the light-emitting elements 2x emits the detection light Lx for 0.1 ms, light-receiving signals from five of the light-receiving element 3x can be simultaneously converted into a digital form. Further, when two of the light-emitting elements 2x simultaneously emit the detection lights Lx, light-receiving signals from ten of the light-receiving elements 3x can be simultaneously converted into a digital form.

Thus, the first local sequential scanning process and the first and second local simultaneous scanning processes can he accelerated.

### Modifications

It should be appreciated that the scope of the invention is not limited to the above exemplary embodiments but modifications and improvements that are compatible with an object of the invention are included within the scope of the invention.

Although the reference number, i.e., the number of detectable light-blocking objects, is exemplarily two or three in the above exemplary embodiments, the reference number may be four or larger. When the reference number is exemplarily M and light-blocking objects less than M are detected, the scanner 161 may conduct the entire simultaneous scanning process or the entire sequential scanning process (hereinafter referred to as “entire scanning process”) in parallel with the local simultaneous scanning process or the local sequential scanning process (hereinafter referred to as “local scanning process”) for scanning a local area around each light-blocking object. As a result, when another light-blocking object (i.e., the Mth light-blocking object) is detected, the scanner 161 may terminate the entire scanning process and conduct only the local scanning process for each of the M light-blocking objects.

It is described above that when the reference number is two and the second light-blocking object is detected, the entire scanning process is terminated and only the local scanning process for each of the two light-blocking objects is conducted. However, when the reference number is M, the local scanning process for each of the M light-blocking objects may be conducted in parallel with the entire scanning process without terminating the entire scanning process. In this arrangement, when the (M+1)th light-blocking object is detected by the entire scanning process, the (M+1)th light-blocking object is ignored. However, when one of the M light-blocking objects becomes undetected, the local scanning process for the (M+1)th light-blocking object is conducted.

In this arrangement, the local scanning processes for the M light-blocking objects may be sequentially conducted or may be simultaneously conducted. In this case, the local scanning processes for the M light-blocking objects are preferably conducted in synchronization with the entire scanning process. This contributes to avoidance of malfunction caused by simultaneously conducting the local scanning process and the entire scanning process.

Although it is described above that the first local simultaneous scanning time is one sixteenth of the entire sequential scanning time, the first local simultaneous scanning time may be the same as the entire sequential scanning time. In other words, the local scanning process may be conducted only once while the entire scanning process is conducted once. Further, the local scanning process may be conducted asynchronously with the entire scanning process. In other words, it is only required that the entire scanning and the local scanning are not simultaneously conducted for a coordinate point.

The scanner 161 may allow the detection lights Lx for the local X-axis scanning process and the detection lights Ly for the local Y-axis scanning process to be emitted in the vicinity of the first light-blocking object Q1 only in the mutually orthogonal directions. For detecting the coordinate position of the first light-blocking object Q1, the scanner 161 may activate the light-emitting elements to emit the detection lights Lx for the local X-axis scanning process in the vicinity of the first light-blocking object Q1 only in parallel with one another. In this arrangement, the coordinate position of the first light-blocking object Q1 may be detected based on the emission position signal relating to the light-emitting element 2x that has emitted the detection light Lx and the light-receiving level Jx at the light-receiving element 3x.

The scanner 161 may activate the light-emitting elements to emit the detection lights Lx for the entire X-axis scanning process and the detection lights Ly for the entire Y-axis scanning process not only in the mutually orthogonal directions but also in the directions obliquely intersecting with each other. The scanner 161 may detect the coordinate position of the light-blocking object with the detection lights Lx emitted only in parallel with one another.

In regard to control of the scanning state of the entire scanning process, not all the light-emitting elements 2x and 2y but only the light-emitting elements 2x and 2y related to odd ordinal numbers in arrangement sequences along the sides of the display surface may sequentially emit light for scanning. When the reference number is M, the entire scanning process, which is conducted in parallel with the local scanning process, may be conducted at a slower speed as more light-blocking objects are detected.

Although it is described above that the light-emitting elements 2x are opposed to the light-receiving elements 3x in a one-on-one manner, for instance, the light-emitting elements 2x and the light-receiving elements 3x may be alternately arranged and may be different in number from each other. For instance, the light-emitting elements 2x may be more than the light-receiving elements 3x or the light-emitting elements 2x may be less than the light-receiving elements 3x. Likewise, the light-emitting elements 2y and the light-receiving elements 3y may also be alternately arranged and may be different in number from each other.

The respective coordinates of the first and second light-blocking objects Q1 and Q2 may be detected based on the respective light-receiving levels of plural adjacent ones of the light-receiving elements 3y. Specifically, when light is blocked at a position distant from the light-receiving element 3y2, the respective light-receiving levels of the light-receiving elements 3y2, 3(y2+1) and 3(y2−1) are lowered. This is because the second light-blocking object Q2 exists on lines connecting the light-emitting element 2y2 to the light-receiving elements 3y2, 3(y2+1) and 3(y2−1). On the other hand, when light is blocked at a position close to the light-receiving element 3y1, the light-receiving level of the light-receiving element 3y1 is lowered but the respective light-receiving levels of the light-receiving elements 3(y1+1) and 3(y1−1) are not lowered. This is because the first light-blocking object Q1 exists on a line connecting the light-emitting element 2y1 to the light-receiving element 3y1 but not on lines connecting the light-emitting element 2y1 to the light-receiving elements 3(y1+1) and 3(y1−1). Based on the above relationships, the respective coordinates of the first and second light-blocking objects Q1 and Q2 may be specified.

The display device according to any one of the exemplary embodiments may be applicable as a display device for portable or desktop personal computers or game consoles or for mobile terminals such as a mobile phone and a PDA (Personal Digital Assistant), and may be applicable as operating devices for an electronic apparatus, a navigation device and the like. Additionally, the display device may be applicable as a display device for a television system at home or in a factory, a bank ATM, or the like.

Although it is described that each of the above functions is a form of a program, it may be a form of hardware such as a circuit board or an element such as one IC (Integrated Circuit), and is usable in either form. When each function is read from a program or a separate recording medium, it is possible to achieve easy handling and to easily enhance versatility as described above.

Specific arrangements and processes according to the invention may be altered as needed upon implementation as long as an object of the invention can be achieved.

### Advantages of Exemplary Embodiment

As described above, in the above exemplary embodiment, when the first light-blocking object Q1 is detected, the scanner 160 of the display device 100 conducts the first local simultaneous scanning process for scanning the local area R1 including the first light-blocking object Q1 and the entire sequential scanning process.

Thus, after the detection of the coordinates of the first light-blocking object Q1, only the vicinity of the first light-blocking object Q1 is scanned, so that the coordinates of the first light-blocking object Q1 can be detected with a high responsiveness. Further, even after the detection of the coordinates of the first light-blocking object Q1, the entire sequential scanning process is continued, so that the coordinates of the second light-blocking object Q2 can also be reliably detected simultaneously with detection of the coordinates of the first light-blocking object Q1.

A predetermined area is scanned in a so-called infrared blocking method according to which the infrared detection lights Lx and Ly emitted from the light-emitting elements 2x and 2y are received by the light-receiving elements 3x and 3y, respectively. Thus, the respective coordinates of the first and second light-blocking objects Q1 and Q2 can be easily detected by scanning the predetermined area with a simple arrangement.

### INDUSTRIAL APPLICABILITY

The invention is applicable as a coordinate position detecting device, a method of detecting a coordinate position, and a display device.

### EXPLANATION OF CODES

1 . . . display surface

100, 100A, 100B, 100C . . . display device

110 . . . display

160, 160A, 160B, 160C . . . controller as a coordinate position detecting device and a computer

161, 161A, 161B, 161C . . . scanner

162 . . . coordinate detector

1. A coordinate position detecting device comprising:
a plurality of light-emitting elements being configured to sequentially emit a detection light in mutually intersecting directions along a planar direction of a display surface;
a plurality of light-receiving elements being disposed at positions correspondingly opposed to the plurality of light-emitting elements to sequentially receive the emitted detection light so that when the detection light is blocked by a light-blocking object, a coordinate position of a light-blocked portion is detected based on a light-receiving amount of the light-receiving elements;
a scanner being configured to scan a predetermined scanning area with the detection light; and
a coordinate detector being configured to detect a coordinate position of the light-blocking object on the display surface based on a scanning position at which the light-blocking object blocks the detection light, wherein
when the coordinate detector detects the coordinate position of the light-blocking object less than a present plural reference number, the scanner is configured to conduct in parallel: a oblique-part scanning process in which the detection light is emitted from each one of the light-emitting elements and received by two or more of the light-receiving elements including one of the light-receiving elements opposed to the one of the light-emitting elements so as to sequentially scan only a vicinity of the light-blocking object less than the reference number; and an entire scanning process in which the detection light is emitted from each one of the light-emitting elements and received only by the light-receiving element opposed to the one of the light-emitting elements so as to sequentially scan an entirety of the display surface.

2. The coordinate position detecting device according to claim 1, wherein
when the number of the light-blocking object is equal to the reference number and the coordinate detector detects the coordinate position of the reference number of the light-blocking object, only the oblique-part scanning process for the reference number of the light-blocking object is conducted.

3. The coordinate position detecting device according to claim 1, wherein
a scanning time of the oblique-part scanning process is one half of a scanning time of the entire scanning process or less.

4. The coordinate position detecting device according to claim 1, wherein
the scanner is configured to synchronously conduct the oblique-part scanning process and the entire scanning process.

5. The coordinate position detecting device according to claim 1, wherein
the scanner is configured to control a scanning speed of the entire scanning process depending on the number of the light-blocking object whose coordinate position is detected by the coordinate detector.

6. A display device comprising:
a display comprising a display surface; and
the coordinate position detecting device according to claim 1, the coordinate position detecting device being configured to detect a coordinate position of a portion light-blocked by a light-blocking object when a detection light emitted in mutually intersecting directions along a planar direction of the display surface of the display is blocked by the light-blocking object.

7. A coordinate position detecting method for a computer to detect a coordinate position of a portion light-blocked by a light-blocking object when a detection light emitted in mutually intersecting directions along a planar direction of a display surface is blocked by the light-blocking object, the method comprising:
scanning a predetermined scanning area with the detection light, the scanning being conducted by the computer; and
detecting a coordinate position of the light-blocking object on the display surface based on a scanning position at which the light-blocking object blocks the detection light, the detecting being conducted by the computer, wherein
in the scanning,
when the coordinate position of the light-blocking object less than a preset reference number is detected in the detecting, an oblique-part scanning process in which only a vicinity of the light-blocking object less than the reference number is sequentially scanned and an entire scanning process in which an entirety of the display surface is sequentially scanned are conducted in parallel,
the detection light used for the oblique-part scanning process is provided by a mutually parallel light, an orthogonal light and an obliquely intersecting light, and
a scanning time of the oblique-part scanning process is one half of a scanning time of the entire scanning process or less.

8. The coordinate position detecting method according to claim 7, wherein
the detection light used for the entire scanning process is provided only by the mutually parallel light and the orthogonal light.
